(19) United States
(12) Patent Application Publication
(10) Pub. No.: US 2020/0128516 A1
(43) Pub. Date: Apr. 23, 2020

(54) Wireless Communication Method, Terminal Device, and Network Device

(71) Applicant: GUANGDONG OPPO MOBILE TELECOMMUNICATIONS CORP., LTD, Dongguan, Guangdong (CN)

(72) Inventors: Zhi Zhang, Dongguan, Guangdong (CN); Wenhong Chen, Dongguan, Guangdong (CN)

(21) Appl. No.: 16/624,407

(22) PCT Filed: Jul. 26, 2017
(86) PCT No.: PCT/CN2017/094527

§ 371 Date: Dec. 19, 2019

(51) Int. Cl. H04W 72/04; H04L 5/00; H04W 52/02

(52) U.S. Cl. CPC H04W 72/042; H04W 52/0216; H04L 5/0053; H04W 72/044

(57) ABSTRACT

Provided in the implementations of the present application are a wireless communication method, terminal device, and network device. The method includes: receiving first information by a terminal device, wherein the first information is used for indicating that downlink control information (DCI) or physical downlink shared channels (PDSCHs) having the same content are transmitted on multiple resources or resource groups; and when detecting the DCI or PDSCH in at least one resource or resource group of the multiple resources or resource groups, stopping, by the terminal device, detecting the DCI or PDSCHs having the same content on other resources or resource groups of the multiple resources or resource groups.

### CROSS-REFERENCE TO RELATED APPLICATION(S)

This application is a 371 application of International Application No. PCT/CN2017/094527, filed on Jul. 26, 2017, the entire disclosure of which is hereby incorporated by reference.

### TECHNICAL FIELD

The present application relates to the field of communications, and more particularly, to a wireless communication method and device.

### BACKGROUND

In a Long Term Evolution (LTE) system, a base station sends Downlink Control Information (DCI) to a terminal device, and the DCI can schedule the terminal device. For example, it can carry scheduling information of a Physical Downlink Shared Channel (PDSCH).

In the future 5G system, requirements for reliability of downlink transmission and power consumption of a terminal device are higher.

How to improve reliability of downlink transmission and reduce power consumption required by a terminal device in DCI or PDSCH transmission is an urgent problem to be solved.

### SUMMARY

Provided in the implementations of the present application are a wireless communication method and device, capable of improving reliability of downlink transmission and reducing power consumption required by a terminal device.

In a first aspect, a wireless communication method is provided. The method includes: receiving first information by a terminal device, wherein the first information is used for indicating that downlink control information (DCI) or physical downlink shared channels (PDSCHs) having the same content are transmitted on multiple resources or resource groups; and, when the DCI or PDSCH is detected in at least one resource or resource group of the multiple resources or resource groups, stopping, by the terminal device, detecting the DCI or PDSCHs having the same content on other resources or resource groups of the multiple resources or resource groups.

Therefore, in an implementation of the present application, a network device sends first information to a terminal device, and the first information is used for indicating that DCI or PDSCHs having the same content are transmitted on multiple resources or resource groups. After the terminal device receives the first information, when the DCI or PDSCH is detected in at least one resource or resource group of the multiple resources or resource groups, the terminal device stops detecting the DCI or PDSCHs having the same content on other resources or resource groups of the multiple resources or resource groups. Therefore, the method enables the DCI or PDSCH to be transmitted multiple times to ensure the reliability of transmission, and the terminal device detects the DCI or PDSCH on at least one resource or resource group and no longer detects the DCI or PDSCHs on other resources or resource groups, thus reducing the power consumption of the terminal device.

In combination with the first aspect, in one possible implementation of the first aspect, the first information is used for indicating that the DCI or PDSCHs having the same content are transmitted on multiple time-frequency resources or time-frequency resource groups.

In combination with the first aspect or any one of the above possible implementations, in another possible implementation of the first aspect, the DCI or PDSCHs transmitted on different time-frequency resources or time-frequency resource groups among the multiple time-frequency resources or time-frequency resource groups are transmitted through different beams.

In combination with the first aspect or any one of the above possible implementations, in another possible implementation of the first aspect, the first information is used for indicating that the DCI or PDSCHs having the same content are transmitted on multiple beams or beam groups.

In combination with the first aspect or any one of the above possible implementations, in another possible implementation of the first aspect, the first information is used for carrying identification information of the DCI.

In combination with the first aspect or any one of the above possible implementations, in another possible implementation of the first aspect, the identification information is used for indicating: at least part of content of the DCI and/or a format of the DCI.

In combination with the first aspect or any above possible implementation thereof, in another possible implementation of the first aspect, the method further includes: when the at least part of content of the DCI is detected in the at least one resource or resource group and/or the format of the DCI detected is a format indicated by the identification information, determining that the DCI is detected in the at least one resource or resource group.

In combination with the first aspect or any one of the above possible implementations, in another possible implementation of the first aspect, when the first information is used for indicating that the PDSCHs having the same content are transmitted on multiple time-frequency resources or time-frequency resource groups, the first information indicates resource positions of the multiple time-frequency resources or time-frequency resource groups.

In combination with the first aspect or any one of the above possible implementations, in another possible implementation of the first aspect, when the first information is used for indicating that the DCI having the same content is transmitted on multiple time-frequency resources or time-frequency resource groups, the first information indicates a control resource set to which at least part of the multiple time-frequency resources or time-frequency resource groups belong.

In combination with the first aspect or any one of the above possible implementations, in another possible implementation of the first aspect, the first information is carried in each piece of the DCI having the same content, and the first information indicates a control resource set to which time-frequency resources or time-frequency resource groups, used for other pieces of the DCI having the same content, belong.

In combination with the first aspect or any one of the above possible implementations, in another possible implementation of the first aspect, when the DCI or PDSCH is detected in at least one resource or resource group of the multiple resources or resource groups, stopping, by the terminal device, detecting the DCI or PDSCHs having the same content on other resources or resource groups of the multiple resources or resource groups, includes: when the DCI is detected through blind detection in a control resource set to which at least one time-frequency resource or time-frequency resource group of the multiple time-frequency resources or time-frequency resource groups belongs through a blind detection method, stopping, by the terminal device, detecting the DCI having the same content in a control resource set to which other resources or resource groups belong.

In combination with the first aspect or any one of the above possible implementations, in another possible implementation of the first aspect, the multiple time-frequency resources or time-frequency resource groups belong to a same control resource set; or at least two time-frequency resources or time-frequency resource groups of the multiple time-frequency resources or time-frequency resource groups belong to different control resource sets.

In combination with the first aspect or any one of the above possible implementations, in another possible implementation of the first aspect, transmission on time-frequency resources in the same control resource set uses one or multiple beams; or transmission on time-frequency resources in different control resource sets uses different or identical beams.

In a second aspect, a wireless communication method is provided. The method includes: receiving, by a terminal device, multiple first signalings, wherein the first signalings carry identifications of PDSCHs and are used for indicating resources used for the PDSCHs, and various first signalings respectively indicate different resources or resource groups; and when the identifications of the PDSCHs carried in the multiple first signalings are identical, when the PDSCH is detected in at least one resource or resource group of the multiple resources or resource groups indicated by the multiple first signalings, stopping, by the terminal device, detecting the PDSCHs on other resources or resource groups of the multiple resources or resource groups.

Therefore, in an implementation of the present application, a network device sends multiple first signalings, and the first signalings carry identifications of PDSCHs and are used for indicating resources used for the PDSCHs. Various first signalings respectively indicate different resources or resource groups, and the identifications of the PDSCHs carried in the multiple first signaling are identical, when the terminal device determines that the identifications of the PDSCHs carried in the multiple first signalings are identical, when the PDSCH is detected in at least one resource or resource group of the multiple resources or resource groups indicated by the multiple first signalings, the terminal device stops detecting the PDSCHs on other resources or resource groups of the multiple resources or resource groups. Therefore, the method enables the PDSCH to be transmitted multiple times to ensure the reliability of transmission, and the terminal device detects the PDSCH on at least one resource or resource group and no longer detects the PDSCHs on other resources or resource groups, thus reducing the power consumption of the terminal device.

In combination with the second aspect, in one possible implementation of the second aspect, the method further includes: when the identifications of the PDSCHs carried in the multiple first signalings are different, receiving the PDSCHs on multiple resources or resource groups respectively.

In combination with the second aspect or any one of the above possible implementations, in another possible implementation of the second aspect, the first signalings are used for indicating time-frequency resources or time-frequency resource groups used for the PDSCHs.

In combination with the second aspect or any one of the above possible implementations, in another possible implementation of the second aspect, the PDSCHs on the time-frequency resources or the time-frequency resource groups respectively indicated by various first signalings are sent through different beams.

In combination with the second aspect or any one of the above possible implementations, in another possible implementation of the second aspect, the first signalings are used for indicating beams or beam groups used for the PDSCHs.

In a third aspect, a wireless communication method is provided. The method includes: sending first information by a network device, wherein the first information is used for indicating that DCI or PDSCHs having the same content are transmitted on multiple resources or resource groups; and transmitting the DCI or PDSCHs having the same content on the multiple resources or resource groups.

In combination with the third aspect, in one possible implementation of the third aspect, the first information is used for indicating that the DCI or PDSCHs having the same content are transmitted on multiple time-frequency resources or time-frequency resource groups.

In combination with the third aspect or any one of the above possible implementations, in another possible implementation of the third aspect, the DCI or PDSCHs transmitted on various time-frequency resources or time-frequency resource groups among the multiple time-frequency resources or time-frequency resource groups are transmitted through different beams.

In combination with the third aspect or any one of the above possible implementations, in another possible implementation of the third aspect, the first information is used for indicating that the DCI or PDSCHs having the same content are transmitted on multiple beams or beam groups.

In combination with the third aspect or any one of the above possible implementations, in another possible implementation of the third aspect, the first information is used for carrying identification information of the DCI.

In combination with the third aspect or any one of the above possible implementations, in another possible implementation of the third aspect, the identification information is used for indicating: at least part of content of the DCI and/or a format of the DCI.

In combination with the third aspect or any one of the above possible implementations, in another possible implementation of the third aspect, when the first information is used for indicating that the PDSCHs having the same content are transmitted on multiple time-frequency resources or time-frequency resource groups, the first information indicates resource positions of the multiple time-frequency resources or time-frequency resource groups.

In combination with the third aspect or any one of the above possible implementations, in another possible implementation of the third aspect, when the first information is used for indicating that the DCI having the same content is transmitted on multiple time-frequency resources or time-frequency resource groups, the first information indicates a control resource set to which at least part of the multiple time-frequency resources or time-frequency resource groups belong.

In combination with the third aspect or any one of the above possible implementations, in another possible implementation of the third aspect, the first information is carried in each piece of the DCI having the same content, and the first information indicates a control resource set to which time-frequency resources or time-frequency resource groups, used for other pieces of the DCI having the same content, belong.

In combination with the third aspect or any one of the above possible implementations, in another possible implementation of the third aspect, the multiple time-frequency resources or time-frequency resource groups belong to a same control resource set; or at least two time-frequency resources or time-frequency resource groups of the multiple time-frequency resources or time-frequency resource groups belong to different control resource sets.

In combination with the third aspect or any one of the above possible implementations, in another possible implementation of the third aspect, transmission on time-frequency resources in the same control resource set uses one or multiple beams; or transmission on time-frequency resources in different control resource sets uses different or identical beams.

In a fourth aspect, a wireless communication method is provided. The method includes: sending, by a network device, multiple first signalings, wherein the first signalings carry identifications of PDSCHs and are used for indicating resources used for the PDSCHs, various first signalings respectively indicate different resources or resource groups, and the identifications of the PDSCHs carried in the multiple first signaling are identical; and sending the PDSCHs having the same content on multiple resources or resource groups indicated by the multiple first signalings.

In combination with the fourth aspect, in one possible implementation of the fourth aspect, the first signalings are used for indicating time-frequency resources or time-frequency resource groups used for the PDSCHs.

In combination with the fourth aspect or any one of the above possible implementations, in another possible implementation of the fourth aspect, the PDSCHs on the time-frequency resources or the time-frequency resource groups respectively indicated by various first signalings are sent through different beams.

In combination with the fourth aspect or any one of the above possible implementations, in another possible implementation of the fourth aspect, the first signalings are used for indicating beams or beam groups used for the PDSCHs.

In a fifth aspect, a terminal device is provided, which is used for performing the method in the above first aspect or any possible implementation of the first aspect or the method in the above second aspect or any possible implementation of the second aspect. Specifically, the terminal device includes function modules used for executing the method in the first aspect or any possible implementation of the first aspect or the method in the second aspect or any possible implementation of the second aspect described above.

In a sixth aspect, a network device is provided, which is used for performing the method in the above third aspect or any possible implementation of the third aspect or the method in the above fourth aspect or any possible implementation of the fourth aspect. Specifically, the network device includes function modules used for executing the method in the third aspect or any possible implementation of the third aspect or the method in the fourth aspect or any possible implementation of the fourth aspect described above.

In a seventh aspect, a terminal device is provided, which includes a processor, a memory, and a transceiver. The processor, the memory, and the transceiver communicate with each other through internal connection paths to transfer control and/or data signals, so that the network device executes the method in the first aspect or any possible implementation of the first aspect or the method in the second aspect or any possible implementation of the second aspect described above.

In an eighth aspect, a network device is provided, which includes a processor, a memory, and a transceiver. The processor, the memory, and the transceiver communicate with each other through internal connection paths to transfer control and/or data signals, so that the network device executes the method in the third aspect or any possible implementation of the third aspect or the method in the fourth aspect or any possible implementation of the fourth aspect described above.

In a ninth aspect, a computer readable medium for storing a computer program is provided. The computer program includes instructions for executing any method or any possible implementation described above.

In a tenth aspect, a computer program product containing instructions is provided. When running on a computer, the computer program product causes the computer to execute any method or the method in any possible implementation described above.

### BRIEF DESCRIPTION OF DRAWINGS

To describe the technical solution of implementations of the present application more clearly, accompanying drawings that need to be used in the description of implementations or the prior art will be briefly introduced below. It is apparent that the accompanying drawings described below are only some implementations of the present application; and for a person of ordinary skill in the art, other drawings may be obtained according to these drawings without paying an inventive effort.

FIG. 1 is a schematic diagram of a wireless communication system according to an implementation of the present application.

FIG. 2 is a schematic flowchart of a wireless communication method according to an implementation of the present application.

FIG. 3 is a schematic flowchart of a wireless communication method according to an implementation of the present application.

FIG. 4 is a schematic block diagram of a terminal device according to an implementation of the present application.

FIG. 5 is a schematic block diagram of a network device according to an implementation of the present application.

FIG. 6 is a schematic block diagram of a system chip according to an implementation of the present application.

FIG. 7 is a schematic block diagram of a communication device according to an implementation of the present application.

### DETAILED DESCRIPTION

The technical solution in implementations of the present application will be described below with reference to the drawings in implementations of the present application. It is apparent that the implementations described are just some implementations of the present application, but not all implementations of the present application. Based on the implementations of the present application, all other implementations achieved by a person of ordinary skill in the art without paying an inventive effort are within the protection scope of the present application.

The technical solution of the implementations of the present application may be applied to various communication systems, such as a Global System of Mobile communication (GSM) system, a Code Division Multiple Access (CDMA) system, a Wideband Code Division Multiple Access (WCDMA) system, a General Packet wireless Service (GPRS) system, a Long Term Evolution (LTE) system, a LTE Frequency Division Duplex (FDD) system, a LTE Time Division Duplex (TDD) system, a Universal Mobile Telecommunication System (UMTS) system, a Worldwide Interoperability for Microwave Access (WiMAX) communication system, or a future 5G system (it can be called as a New Radio (NR) system).

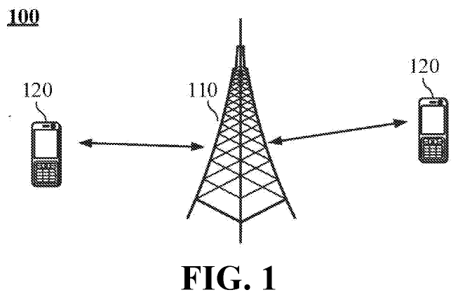

FIG. 1 shows a wireless communication system 100 to which an implementation of the present application is applied. The wireless communication system 100 may include a network device 110. The network device 110 may be a device that communicates with a terminal device. The network device 110 may provide communication coverage for a specific geographical area, and may communicate with a terminal device (e.g., UE) in the coverage area. Optionally, the network device 110 may be a Base Transceiver Station (BTS) in a GSM system or CDMA system, a NodeB (NB) in a WCDMA system, an Evolutional Node B (eNB or eNodeB) in an LTE system, or a radio controller in a Cloud Radio Access Network (CRAN). Or the network device may be a relay station, an access point, a vehicle-mounted device, a wearable device, a network side device in a future 5G network, or a network device in a future evolved Public Land Mobile Network (PLMN), etc.

The wireless communication system 100 further includes at least one terminal device 120 in the coverage area of the network device 110. The terminal device 120 may be mobile or fixed. Optionally, the terminal device 120 may be referred to as an access terminal, a User Equipment (UE), a subscriber unit, a subscriber station, a mobile station, a remote station, a remote terminal, a mobile device, a user terminal, a terminal, a wireless communication device, a user agent, or a user apparatus. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device, or other processing device connected to a wireless modem, a vehicle-mounted device, a wearable device, a terminal device in a future 5G network, or a terminal device in a future evolved Public Land Mobile Network (PLMN), or the like.

Optionally, Device to Device (D2D) communication may be performed between the terminal devices 120.

Optionally, the 5G system or network may also be referred to as a New Radio (NR) system or network.

FIG. 1 illustrates an example of one network device and two terminal devices. Optionally, the wireless communication system 100 may include multiple network devices, and other quantity of terminal devices may be included within the coverage area of each network device, which is not limited in implementations of the present application.

Optionally, the wireless communication system 100 may further include other network entities such as a network controller, a mobile management entity, and implementations of the present application are not limited thereto.

It should be understood that the terms “system” and “network” are often used interchangeably in this document. The term “and/or” in this document is merely an association relationship describing associated objects, indicating that there may be three relationships, for example, A and/or B may indicate three cases: A alone, A and B, and B alone. In addition, the symbol “/” in this document generally indicates that objects before and after the symbol “/” have an “or” relationship.

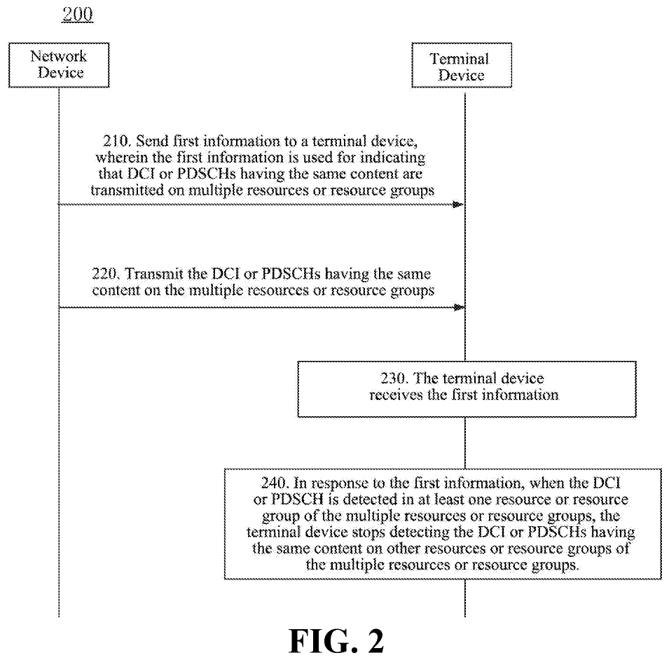

FIG. 2 is a schematic flowchart of a wireless communication method 200 according to an implementation of the present application. The method 200 may optionally be applied to, but not limited to, the system shown in FIG. 1. The method 200 includes at least some of the following contents.

In act 210, a network device sends first information to a terminal device, wherein the first information is used for indicating that DCI or PDSCHs having the same content are transmitted on multiple resources or resource groups.

Optionally, the resources or resource groups indicated by the first information herein may be time domain resources, frequency domain resources, code domain resources, or spatial domain resources, etc.

For example, in one implementation, the first information is used for indicating that the DCI or PDSCHs having the same content are transmitted on multiple time-frequency resources or time-frequency resource groups.

The DCI or PDSCHs transmitted on different time-frequency resources or time-frequency resource groups among the multiple time-frequency resources or time-frequency resource groups are transmitted through different beams. However, the terminal device is not “aware of” the difference in beams for transmitting the DCI or PDSCHs.

Here, multiple time-frequency resources or resource groups may correspond to multiple beams, for example, DCI on different symbols is transmitted using different beams. For example, DCI having the same content is transmitted on beam 1, beam 2, and beam 3, and symbol 1, symbol 2, and symbol 3 are transmitted using beam 1, beam 2, and beam 3, respectively. The DCI transmitted on beam 1 (symbol 1) indicates that DCI having the same content is also transmitted on symbol 2 and symbol 3. The DCI transmitted on beam 2 (symbol 2) indicates that DCI having the same content is also transmitted on symbol 1 and symbol 3. The DCI transmitted on beam 3 (symbol 3) indicates that DCI having the same content is also transmitted on symbol 2 and symbol 1.

For example, in another implementation, the first information is used for indicating that the DCI or PDSCHs having the same content are transmitted on multiple beams or beam groups.

Specifically, the first information may directly carry information of beams or beam groups for transmitting the DCI or PDSCHs.

Optionally, the DCI in the implementation of the present application may be UE specific DCI or group common DCI.

Optionally, when the first information is used for indicating that the DCI having the same content is transmitted on multiple resources or resource groups, the first information can be carried in the DCI.

For example, when a network device sends DCI on a resource, the network device will also indicate in the DCI whether DCI having the same content is broadcast on other resources. If so, the network device will also provide information of the other resources and carry it in the DCI.

In act 220, DCI or PDSCHs having the same content are transmitted on the multiple resources or resource groups.

In act 230, the terminal device receives the first information.

In act 240, in response to the first information, when the DCI or PDSCH is detected in at least one resource or resource group of the multiple resources or resource groups, the terminal device stops detecting the DCI or PDSCHs having the same content on other resources or resource groups of the multiple resources or resource groups.

Optionally, when the first information is used for indicating that PDSCHs having the same content are transmitted on multiple time-frequency resources or time-frequency resource groups, the first information indicates resource positions of the multiple time-frequency resources or time-frequency resource groups.

Specifically, the network device may indicate specific positions of the time-frequency resources or resource groups used for the PDSCHs having the same content in the first information, and detection of the PDSCHs (not blind detection) at other positions is stopped if the PDSCH is detected (not blind detection) at a position.

Optionally, when the first information is used for indicating that DCI having the same content is transmitted on multiple time-frequency resources or time-frequency resource groups, the first information indicates a control resource set to which at least part of the multiple time-frequency resources or time-frequency resource groups belong.

Optionally, the control resource set is configured by the network device to the terminal device through a high-level signaling, such as Radio Resource Control (RRC). When configuring the control resource set to the terminal device, the network device may notify the terminal device in advance that, some DCI may be transmitted on multiple time-frequency resources or time-frequency resource groups. The notification message may carry all the control resource sets used for time-frequency resources for transmitting the DCI having the same content.

At least two transmissions of DCI having the same content may use resources in one control resource set, or different transmissions of DCI having the same content may use resources in different control resource sets.

Optionally, the first information is used for carrying identification information of the DCI. Optionally, the identification information is used for indicating: at least part of content of the DCI and/or a format of the DCI.

Optionally, when at least part of content of the DCI is detected in at least one resource or resource group and/or the format of the DCI detected is a format indicated by the identification information, it is determined that the DCI is detected in the at least one resource or resource group.

Optionally, the network device may notify the terminal device of an identification of the DCI. The identification may be a part of the content carried in the DCI, or the identification may be the specific format of the DCI (the terminal needs to detect the specific format of DCI when receiving DCI). When the terminal device detects DCI containing the above identification on a time-frequency resource, the terminal will not go to other time-frequency resources to detect DCI having the same content again, thus achieving the purpose of saving power consumption of the terminal device.

Optionally, the first information is carried in each piece of the DCI having the same content, and the first information indicates a control resource set to which time-frequency resources or time-frequency resource groups used for other pieces of the DCI (DCI which the first information is not carried in) having the same content belong.

Optionally, when the DCI is detected through blind detection in a control resource set to which at least one resource or resource group of the multiple resources or resource groups belongs by using a blind detection method, the terminal device stops performing the blind detection on the DCI having the same content in a control resource set to which other resources or resource groups belong.

Optionally, if the first information is carried in the DCI, the first information indicates a control resource set to which time-frequency resources or time-frequency resource groups for transmitting other DCI having the same content belong.

Specifically, in a 5G system, a physical layer control signaling sent by the network device to the terminal device is carried in a PDCCH (downlink control channel). For a terminal device, the PDCCH to be detected is located in the CORESET (control resource set) configured by the network device. The terminal device needs to detect whether there is a physical layer control signaling (such as DCI) from the base station within the CORESET configured by the network device. The CORESET may contain DCI (UE specific search space) for a terminal only, or may contain DCI (group common DCI) for a group of terminals, which sometimes also be referred to as broadcast DCI.

When the terminal device detects the DCI required by it in a control resource set, the network device may indicate in the DCI a control resource set to which other DCI having the same content as the DCI belong. Therefore, the terminal device would not perform blind detection on the DCI having the same content in other control resource sets again.

In other words, the first information does not indicate the specific positions of multiple time-frequency resources or resource groups for transmitting the DCI having the same content, but indicates the control resource set to which the multiple time-frequency resources or resource groups belong. In this case, the terminal device detects DCI on the resources or resource groups, which means that blind detection is performed on the control resource set.

Optionally, the multiple time-frequency resources or time-frequency resource groups belong to a same control resource set; or at least two time-frequency resources or time-frequency resource groups of the multiple time-frequency resources or time-frequency resource groups belong to different control resource sets.

Optionally, the transmission on time-frequency resources in the same control resource set uses one or multiple beams; or the transmission on time-frequency resources in different control resource sets uses different or identical beams.

Therefore, in an implementation of the present application, a network device sends first information to a terminal device, and the first information is used for indicating that DCI or PDSCHs having the same content are transmitted on multiple resources or resource groups. After the terminal device receives the first information, when the DCI or PDSCH is detected in at least one resource or resource group of the multiple resources or resource groups, the terminal device stops detecting the DCI or PDSCHs having the same content on other resources or resource groups of the multiple resources or resource groups. Therefore, the method enables the DCI or PDSCH to be transmitted multiple times to ensure the reliability of transmission, and the terminal device detects the DCI or PDSCH on at least one resource or resource group and no longer detects the DCI or PDSCHs on other resources or resource groups, thus reducing the power consumption of the terminal device.

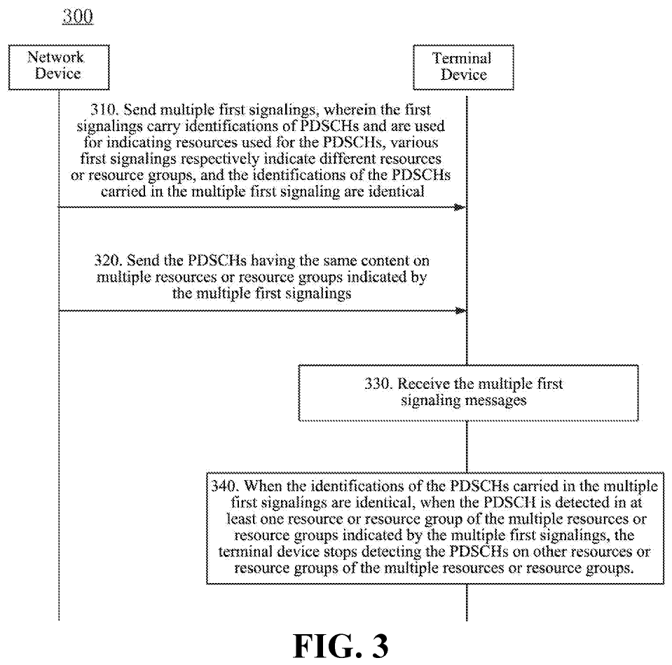

FIG. 3 is a schematic flowchart of a wireless communication method 300 according to an implementation of the present application.

In act 310, a network device sends multiple first signalings, wherein the first signalings carry identifications of PDSCHs and are used for indicating resources used for the PDSCHs, various first signalings respectively indicate different resources or resource groups, and the identifications of the PDSCHs carried in the multiple first signaling are identical.

Optionally, the first signalings are DCI.

In act 320, the PDSCHs having the same content are sent on multiple resources or resource groups indicated by the multiple first signalings.

In act 330, a terminal device receives multiple first signalings, wherein the first signalings carry identifications of physical downlink shared channels (PDSCHs) and are used for indicating resources used for the PDSCHs, and various first signalings respectively indicate different resources or resource groups.

In act 340, when the identifications of the PDSCHs carried in the multiple first signalings are identical, when the PDSCH is detected in at least one resource or resource group of the multiple resources or resource groups indicated by the multiple first signalings, the terminal device stops detecting the PDSCHs on other resources or resource groups of the multiple resources or resource groups.

Specifically, the network device can transmit the same message using PDSCHs on multiple resources or resource groups to enhance the reliability. These PDSCHs may be scheduled by different DCI, optionally indicated by Downlink grant (DL grant) within DCI. In this case, the network device may send to the terminal the indication in the DCI that schedules the transmission of the same PDSCH messages, to avoid repeated detection on the terminal side.

The network device may carry one piece of identification information in the DCI, for example, in the DL grant. The identification information is used for identifying PDSCH content scheduled by the DCI. When PDSCHs scheduled by other DCI also transmit the same content, the network device would carry the same identification in the DCI. When the terminal device receives different DCI scheduling PDSCHs having the same identification, the terminal would not repeatedly detect these PDSCHs, thereby saving power consumption of the terminal.

Optionally, when the identifications of the PDSCHs carried in the multiple first signalings are different, the PDSCHs are received on multiple resources or resource groups respectively.

Optionally, the first signalings are used for indicating time-frequency resources or time-frequency resource groups used for the PDSCHs.

Optionally, the PDSCHs on the time-frequency resources or the time-frequency resource groups respectively indicated by various first signalings are sent through different beams.

Optionally, the first signalings are used for indicating beams or beam groups used for the PDSCHs.

Therefore, in an implementation of the present application, a network device sends multiple first signalings, and the first signalings carry identifications of PDSCHs and are used for indicating resources used for the PDSCHs, and various first signalings respectively indicate different resources or resource groups, and the identifications of the PDSCHs carried in the multiple first signaling are identical. When the terminal device determines that the identifications of the PDSCHs carried in the multiple first signalings are identical, when the PDSCH is detected in at least one resource or resource group of the multiple resources or resource groups indicated by the multiple first signalings, the terminal device stops detecting the PDSCHs on other resources or resource groups of the multiple resources or resource groups. Therefore, the method enables the PDSCH to be transmitted multiple times to ensure the reliability of transmission, and the terminal device detects the PDSCH on at least one resource or resource group and no longer detects the PDSCHs on other resources or resource groups, thus reducing the power consumption of the terminal device.

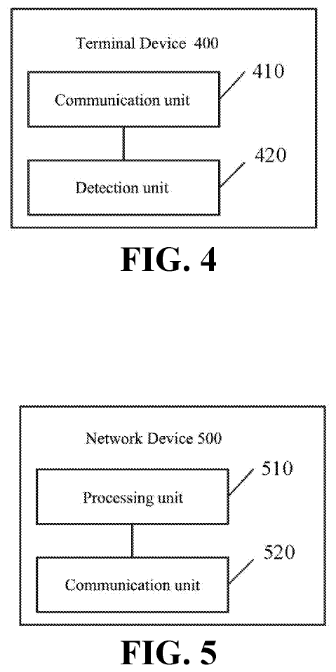

FIG. 4 is a schematic block diagram of a terminal device according to an implementation of the present application. As shown in FIG. 4, the terminal device 400 includes a communication unit 410 and a detection unit 420.

Optionally, the communication unit 410 is used for receiving first information, wherein the first information is used for indicating that DCI or PDSCHs having the same content are transmitted on multiple resources or resource groups. The detection unit 420 is used for, when the DCI or PDSCH is detected in at least one resource or resource group of the multiple resources or resource groups, stopping detecting the DCI or PDSCHs having the same content on other resources or resource groups of the multiple resources or resource groups.

It should be understood that the terminal device 400 may correspond to the terminal device in the method 200, and may implement the corresponding operations implemented by the terminal device in the method 200, which will not be described in detail herein for the sake of brevity.

Optionally, the communication unit 410 is used for receiving multiple first signalings, wherein the first signalings carry identifications of PDSCHs and are used for indicating resources used for the PDSCHs, and various first signalings respectively indicate different resources or resource groups. The detection unit 420 is used for, when the identifications of the PDSCHs carried in the multiple first signalings are identical, when the PDSCH is detected in at least one resource or resource group of the multiple resources or resource groups indicated by the multiple first signalings, stopping detecting the PDSCHs on other resources or resource groups of the multiple resources or resource groups.

It should be understood that the terminal device 400 may correspond to the terminal device in the method 300, and may implement the corresponding operations implemented by the terminal device in the method 300, which will not be described in detail herein for the sake of brevity.

FIG. 5 is a schematic block diagram of a network device 500 according to an implementation of the present application. As shown in FIG. 5, the network device 500 includes a processing unit 510 and a communication unit 520.

Optionally, the processing unit 510 is used for generating first information, wherein the first information is used for indicating that DCI or PDSCHs having the same content are transmitted on multiple resources or resource groups. The communication unit 520 is used for sending the first information and transmitting DCI or PDSCHs having the same content on the multiple resources or resource groups.

It should be understood that the network device 500 may correspond to the network device in the method 200, and may implement the corresponding operations implemented by the network device in the method 200, which will not be described in detail herein for the sake of brevity.

Optionally, the processing unit 510 is used for generating multiple first signalings, wherein the first signalings carry identifications of PDSCHs and are used for indicating resources used for the PDSCHs, various first signalings respectively indicate different resources or resource groups, and the identifications of the PDSCHs carried in the multiple first signaling are identical. The communication unit 520 is used for sending the multiple first signalings, and sending the PDSCHs having the same content on multiple resources or resource groups indicated by the multiple first signalings.

It should be understood that the network device 500 may correspond to the network device in the method 300, and may implement the corresponding operations implemented by the network device in the method 300, which will not be described in detail herein for the sake of brevity.

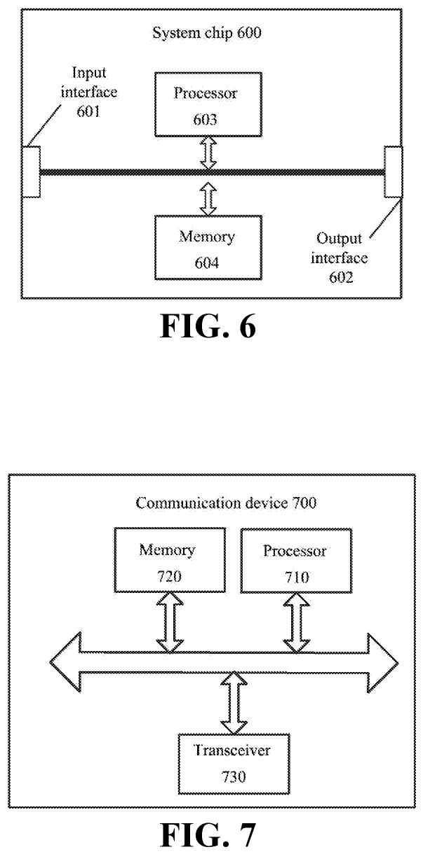

FIG. 6 is a schematic diagram of structure of a system chip 600 according to an implementation of the present application. The system chip 600 of FIG. 6 includes an input interface 601, an output interface 602, a processor 603, and a memory 604, which could be connected through internal communication connection lines. The processor 603 is used for executing codes in the memory 604.

Optionally, when the codes are executed, the processor 603 implements the method implemented by the network device in the method implementations. For sake of conciseness, the specific description will not be repeated here.

Optionally, when the codes are executed, the processor 603 implements the method implemented by the terminal device in the method implementations. For sake of conciseness, the specific description will not be repeated here.

FIG. 7 is a schematic block diagram of a communication device 700 according to an implementation of the present application. As shown in FIG. 7, the communication device 700 includes a processor 710 and a memory 720. The memory 720 may store program codes, and the processor 710 may execute the program codes stored in the memory 720.

Optionally, as shown in FIG. 7, the communication device 700 may include a transceiver 730, and the processor 710 may control the transceiver 730 to communicate with the external.

Optionally, the processor 710 may call the program codes stored in the memory 720 to perform corresponding operations of the network device in the method implementations, which will not be described here repeatedly for brevity.

Optionally, the processor 710 may call the program codes stored in the memory 720 to perform corresponding operations of the terminal device in the method implementations, which will not be described here repeatedly for brevity.

It should be understood that the processor in an implementation of the present disclosure may be an integrated circuit chip with a capability for processing signals. In the implementation process, the acts of the method implementations described above may be accomplished by integrated logic circuits of hardware in the processor or instructions in the form of software. The above processor may be a general purpose processor, a digital signal processor (DSP), an application specific integrated circuit (ASIC), a field programmable gate array (FPGA), or other programmable logic device, discrete gate or transistor logic device, or discrete hardware component. The processor may implement various methods, acts and logic block diagrams disclosed in implementations of the present application. The general purpose processor may be a microprocessor or the processor may be any conventional processor or the like. The acts of the method disclosed in connection with the implementation of the present application may be directly embodied by the execution of the hardware decoding processor, or by the execution of a combination of hardware and software modules in the decoding processor. The software modules may be located in a storage medium commonly used in the art, such as a random access memory, flash memory, read-only memory, programmable read-only memory or electrically erasable programmable memory, or register. The storage medium is located in the memory, and the processor reads the information in the memory and accomplishes the acts of the above method in combination with its hardware.

It should be understood that the memory in implementations of the present application may be a transitory memory or non-transitory memory, or may include both transitory and non-transitory memory. The non-transitory memory may be a read-only memory (ROM), programmable ROM (PROM), an erasable programmable ROM (EPROM), an electrically erasable programmable ROM (EEPROM), or a flash memory. The transitory memory may be a random access memory (RAM) which serves as an external cache. As an example, but not as a limitation, many forms of RAMs are available, such as a static random access memory (SRAM), a dynamic random access memory (DRAM), a synchronous dynamic random access memory (SDRAM), a double data rate SDRAM (DDR SDRAM), an enhanced SDRAM (ESDRAM), a Synchlink DRAM (SLDRAM), and a Direct Rambus RAM (DR RAM). It should be noted that the memories of the systems and methods described herein are intended to include, but are not limited to, these and any other suitable types of memories.

Those of ordinary skill in the art will recognize that the example units and algorithm acts described in connection with the implementations disclosed herein may be implemented in electronic hardware, or a combination of computer software and electronic hardware. Whether these functions are implemented in hardware or software depends on a specific application and design constraint of the technical solution. Skilled artisans may use different methods to realize the described functions for each particular application, but such realization should not be considered to be beyond the scope of the present application.

Those skilled in the art may clearly understand that for convenience and conciseness of description, the specific working process of the system, apparatus and unit described above may refer to the corresponding process in the implementations of methods described above, and details are not described herein again.

In several implementations provided by the present application, it should be understood that the disclosed system, apparatus and method may be implemented in other ways. For example, the apparatus implementations described above are only illustrative, for another example, the division of the units is only a logical function division, and there may be other division manners in actual realization. For still another example, multiple units or components may be combined or integrated into another system, or some features may be ignored or not executed. On the other hand, the mutual coupling or direct coupling or communication connection shown or discussed may be indirect coupling or communication connection through some interfaces, apparatuses or units, and may be in electrical, mechanical or other forms.

The units described as separated components may or may not be physically separated, and the component shown as a unit may or may not be a physical unit, i.e., it may be located in one place or may be distributed over multiple network units. Some or all of the units may be selected according to practical needs to achieve a purpose of the solution of the implementations.

In addition, various functional units in various implementations of the present application may be integrated in one processing unit, or various units may be physically present separately, or two or more units may be integrated in one unit.

The functions may be stored in a computer readable storage medium if implemented in a form of a software functional unit and sold or used as a separate product. Based on this understanding, the technical solution of the present application, in essence, or the part contributing to the existing art, or the part of the technical solution, may be embodied in the form of a software product stored in a storage medium, including several instructions for causing a computer device (which may be a personal computer, a server, or a network device, etc.) to perform all or part of the acts of the methods described in various implementations of the present application. The aforementioned storage medium includes various media capable of storing program codes, such as a U disk, a mobile hard disk, a read-only memory (ROM), a random access memory (RAM), a magnetic disk, or an optical disk.

The foregoing are merely example implementations of the present application, but the protection scope of the present application is not limited thereto. Any person skilled in the art may easily conceive variations or substitutions within the technical scope disclosed by the present application, which should be included within the protection scope of the present application. Therefore, the protection scope of the present application should be subject to the protection scope of the claims.

1-18. (canceled)

19. A method for wireless communication, comprising:
sending, by a network device, first information, wherein the first information is used for indicating that downlink control information (DCI) or physical downlink shared channels (PDSCHs) having same content are transmitted on multiple resources or resource groups; and,
transmitting the DCI or PDSCHs having the same content on the multiple resources or resource groups.

20. The method according to claim 19, wherein the first information is used for indicating that the DCI or PDSCHs having the same content are transmitted on multiple time-frequency resources or time-frequency resource group wherein the DCI or PDSCHs transmitted on each of the multiple time-frequency resources or time-frequency resource groups is transmitted through a different beam.

21. (canceled)

22. The method according to claim 19, wherein the first information is used for indicating that the DCI or PDSCHs having the same content are transmitted on multiple beams or beam groups.

23. The method according to claim 19, wherein the first information is used for carrying identification information of the DCI, wherein the identification information is used for indicating: at least part of content of the DCI or a format of the DCI.

24. (canceled)

25. The method according to claim 19, wherein when the first information is used for indicating that the PDSCHs having the same content are transmitted on multiple time-frequency resources or time-frequency resource groups, the first information indicates resource positions of the multiple time-frequency resources or time-frequency resource groups.

26. The method according to claim 19, wherein when the first information is used for indicating that the DCI having the same content is transmitted on multiple time-frequency resources or time-frequency resource groups, the first information indicates a control resource set to which at least part of the multiple time-frequency resources or time-frequency resource groups belong.

27-33. (canceled)

34. A terminal device, comprising a transceiver and a processor; wherein:
the transceiver is used for receiving first information, wherein the first information is used for indicating that downlink control information (DCI) or physical downlink shared channels (PDSCHs) having same content are transmitted on multiple resources or resource groups; and
the processor is used for, when the DCI or PDSCHs is detected in at least one resource or resource group of the multiple resources or resource groups, stopping detecting the DCI or PDSCHs having the same content on other resources or resource groups of the multiple resources or resource groups.

35. The terminal device according to claim 34, wherein the first information is used for indicating that the DCI or PDSCHs having the same content are transmitted on multiple time-frequency resources or time-frequency resource groups,
wherein the DCI or PDSCHs transmitted on different time-frequency resources or time-frequency resource groups among the multiple time-frequency resources or time-frequency resource groups are transmitted through different beams.

36. (canceled)

37. The terminal device according to claim 34, wherein the first information is used for indicating that the DCI or PDSCHs having the same content are transmitted on multiple beams or beam groups.

38. The terminal device according to claim 34, wherein the first information is used for carrying identification information of the DCI,
wherein the identification information is used for indicating: at least part of content of the DCI or a format of the DCI.

39. (canceled)

40. The terminal device according to claim 38, wherein the terminal device further comprises:
when the at least part of content of the DCI is detected in the at least one resource or resource group or the format of the DCI detected is a format indicated by the identification information, determining that the DCI is detected in the at least one resource or resource group.

41. The terminal device according to claim 34, wherein when the first information is used for indicating that the PDSCHs having the same content are transmitted on multiple time-frequency resources or time-frequency resource groups, the first information indicates resource positions of the multiple time-frequency resources or time-frequency resource groups.

42. The terminal device according to claim 34, wherein when the first information is used for indicating that the DCI having the same content is transmitted on multiple time-frequency resources or time-frequency resource groups, the first information indicates a control resource set to which at least part of the multiple time-frequency resources or time-frequency resource groups belong.

43. The terminal device according to claim 42, wherein the first information is carried in each piece of the DCI having the same content, and the first information indicates a control resource set to which time-frequency resources or time-frequency resource groups used for other pieces of the DCI having the same content belong.

44. The terminal device according to claim 42, wherein the processor is further used for:
when the DCI is detected through blind detection in a control resource set to which at least one time-frequency resource or time-frequency resource group of the multiple time-frequency resources or time-frequency resource groups belongs through a blind detection method, stopping performing the blind detection on the DCI having the same content in a control resource set to which other resources or resource groups belong,
wherein the multiple time-frequency resources or time-frequency resource groups belong to a same control resource set; or
at least two time-frequency resources or time-frequency resource groups of the multiple time-frequency resources or time-frequency resource groups belong to different control resource sets.

45. (canceled)

46. The terminal device according to claim 44, wherein transmission on time-frequency resources in the same control resource set uses one or multiple beams; or
transmission on time-frequency resources in different control resource sets uses different or identical beams.

47. A terminal device, comprising a transceiver and a processor; wherein:
the transceiver is used for receiving multiple first signalings, wherein the first signalings carry identifications of physical downlink shared channels (PDSCHs) and are used for indicating resources used for the PDSCHs, and the first signalings respectively indicate different resources or resource groups; and
the processor is used for, when the identifications of the PDSCHs carried in the multiple first signalings are identical, when the PDSCHs are detected in at least one resource or resource group of the multiple resources or resource groups indicated by the multiple first signalings, stopping detecting the PDSCHs on other resources or resource groups of the multiple resources or resource groups.

48. The terminal device according to claim 47, wherein the processor is further used for:
when the identifications of the PDSCHs carried in the multiple first signalings are different, detecting the PDSCHs on the multiple resources or resource groups respectively.

49. The terminal device according to claim 47, wherein the first signalings are used for indicating time-frequency resources or time-frequency resource groups used for the PDSCHs,
wherein the PDSCHs on the time-frequency resources or the time-frequency resource groups respectively indicated by the first signalings are sent through different beams.

50. (canceled)

51. The terminal device according to claim 47, wherein the first signalings are used for indicating beams or beam groups used for the PDSCHs.

52-66. (canceled)
